(19) United States
(12) Patent Application Publication
(10) Pub. No.: US 2011/0090424 A1
(43) Pub. Date: Apr. 21, 2011

(54) ILLUMINATION DEVICE AND LIQUID CRYSTAL DISPLAY DEVICE

(75) Inventors: Yuhsaku Ajichi, Osaka-shi (JP); Takeshi Masuda, Osaka-shi (JP); Yukihide Kohtoku, Osaka-shi (JP)

(73) Assignee: SHARP KABUSHIKI KAISHA, Osaka-shi, Osaka (JP)

(21) Appl. No.: 12/997,882

(22) PCT Filed: Apr. 15, 2009
(86) PCT No.: PCT/JP2009/057595

§ 371 Date: Dec. 14, 2010

(30) Foreign Application Priority Data
Jul. 11, 2008 (JP) 2008-181758

(51) Int. Cl. G02F 1/13357; F21V 11/00; F21V 9/00; H05B 37/02

(52) U.S. Cl. 349/62; 362/235; 362/231; 315/294

(57) ABSTRACT

A backlight (illumination device) of the present invention includes a plurality of light source units (32) each of which includes: a plurality of light sources (25) which emit light beams of two or more different colors; and a light guide (27) which mixes colored light beams emitted from the light sources and then converts the colored light beams thus mixed into surface emission. The plurality of light source units (32) are arranged so as not to overlap one another. In the light source unit (32), the plurality of light sources (25) are aligned in a given order along an end part (27d) of the light guide (27), and a light source disposed at a midsection of the end part (27d) of the light guide (27) has the highest luminance intensity among the plurality of light sources (25), and luminous intensities of the other light sources decrease with distance from the light source disposed at the midsection of the end part (27d) of the light guide (27).

### TECHNICAL FIELD

The present invention relates to: an illumination device that includes a plurality of light sources and light guides each of which converts light from the light sources to surface emission; and a liquid crystal display device including the illumination device.

### BACKGROUND ART

A liquid crystal display device has an illumination device provided on a front or back surface of a liquid crystal panel. A light source provided on the back surface of a liquid crystal panel is generally referred to as a backlight. The backlight is classified into the following two types: a direct type backlight having a light source provided directly below a liquid crystal panel; and an edge-light type backlight having a light source disposed on an edge surface of a light guide that guides light to thereby obtain a planar light source.

In both of these two types, cold-cathode fluorescent tubes are generally used as their light sources. However, in order to address environmental problems, etc. there have been recently developed illumination devices using mercury-free light-emitting diodes as light sources (for example, see Patent Literatures 1 through 5).

Cases where white illumination devices are obtained by using light-emitting diodes as light sources are categorized into (i) a case where a white illumination device is obtained by using white light-emitting diodes each of which is constituted by a combination of a blue light-emitting diode and a yellow light-emitting fluorescent material and (ii) a case where a white illumination device is obtained by disposing plural sets of monochromatic light-emitting diodes that respectively emit light beams of different colors, such as red, green, and blue and by mixing the colored light beams emitted from the light-emitting diodes. In recent years, attention has been focused on a backlight in which monochromatic light-emitting diodes that respectively emit light beams of red, green, and blue are used in combination because such a backlight is capable of providing a wide range of color reproduction.

Examples of the direct type backlight include a backlight in which red, green, and blue monochromatic light-emitting diodes are used in combination. Such a backlight has been mass-produced for use in a liquid crystal display device. Such a set of primary color light-emitting diode in which red, green, and blue light-emitting diodes are used in combination needs to obtain white light by mixing colored light beams emitted from the respective light-emitting diodes. For this purpose, a diffusing plate for diffusing light emitted from the light-emitting diodes is provided, or a liquid crystal panel, which is to be irradiated with light, is provided at some distance from the light-emitting diodes. With this configuration, a backlight that uniformly emits white light is obtained.

### Citation List

Patent Literature

Patent Literature 1

Japanese Patent Application Publication, Tokukai, No. 2006-236951 A (Publication Date: Sep. 7, 2006)

Patent Literature 2

Japanese Patent Application Publication, Tokukai, No. 2003-187622 A (Publication Date: Jul. 4, 2003)

Patent Literature 3

Japanese Patent Application Publication, Tokukai, No. 2005-183124 A (Publication Date: Jul. 7, 2005)

Patent Literature 4

Japanese Patent Application Publication, Tokukai, No. 2005-332681 A (Publication Date: Dec. 2, 2005)

Patent Literature 5

Japanese Patent Application Publication, Tokukai, No. 2005-332680 A (Publication Date: Dec. 2, 2005)

### SUMMARY OF INVENTION

Like the above-described illumination device including combinations of red, green, and blue monochromatic light-emitting diodes, an illumination device using a plurality of light sources that emit light beams of different colors obtains white light by mixing the colored light beams. However, such an illumination device has the following problem. On an edge surface of the light guide, light emitted by a light-emitting diode disposed at the furthest edge accounts for a large proportion of the entire light. Therefore, for example, if the color of light emitted by the light-emitting diode disposed at the furthest edge is red, light emitted through a discontinuous side edge surface of the light guide is not quite white, rather a little reddish.

Speaking of an angular property of luminance of light emitted from a light-emitting diode, light of uniform luminance is not emitted from any angles. The luminance of light emitted frontward is highest, and the luminance decreases with increase of an angle from the front. For example, with use of light-emitting diodes of primary colors, R, G, and B, in order to obtain a white light source that achieves sufficient mixture of colored light beams when viewed from the front of the light-emitting diode R, it is necessary that light beams obliquely emitted from the light sources G and B disposed on the right side of the light source R and light beams obliquely emitted from the light sources G and B disposed on the left side of the light source R are guided to a part of a light-emitting section in front of the light source R, so that light beams of R, G, and B are mixed uniformly.

However, for example, at a right side edge surface of the light guide, although colored light beams emitted obliquely to the right from the light sources on the left side are mixed, the amounts of colored lights other than the colored light from the rightmost light-emitting diode decrease because there are no light sources on the right side of the rightmost light-emitting diode. Further, a light beam emitted from the light-emitting diode disposed at the rightmost edge to the right is totally reflected from the right edge of the end surface. This increases the amount of colored light from the rightmost light-emitting diode. As a result, light emitted through side edges of the end surfaces of the light guide are colored with the colors of the light beams from the light-emitting diodes disposed at the furthest edges. This has been the problem with the above configuration.

As a solution to the problem of coloration at the edges of the light guide, Patent Literature 1, paragraph [0035] describes a method of reducing the amount of light from light sources disposed at the edges to about half. The method of adjusting only the amount of light from the light sources disposed at the edges is considered to be effective at reducing the occurrence of coloration at the edge surfaces of the light guide.

However, there is also the problem that coloration occurs, to a lesser extent than at the edge surfaces, in areas positioned slightly inside the side edge surfaces of the light guide (e.g. the areas surrounded by dashed lines in a light-emitting element 100 shown in FIG. 7). The above-described method disclosed in Patent Literature 1 cannot solve the coloration in such areas. As a result, there still occurs unevenness of color of light emitted from the illumination device.

The present invention has been attained in view of the above problems, and an object of the present invention is to realize: an illumination device capable of providing white light generated by sufficient mixture of colored light beams, without coloration attributed to colors of light beams from light sources; and a liquid crystal display device including the illumination device.

In order to solve the above problems, an illumination device according to the present invention includes: a plurality of light sources which emit light beams of two or more different colors; and a plurality of light guides each of which mixes colored light beams emitted from the light sources and then converts the colored light beams thus mixed into surface emission, wherein the plurality of light guides are arranged so as not to overlap one another, the plurality of light sources are aligned in a given order along end parts of each of the light guides, and a light source disposed at a midsection of the end part of the light guide has the highest luminance intensity among the plurality of light sources, and luminous intensities of the other light sources decrease with distance from the light source disposed at the midsection of the end part of the light guide.

An illumination device of the present invention is the so-called tile-type illumination device including a plurality of light sources and a plurality of light guides arranged so as not to overlap one another.

According to the above configuration, the plurality of light guides are arranged each of which converts the light beams from the plurality of light sources into surface emission. This makes it possible to realize sufficient luminance and excellent luminance uniformity even in a case where a large illumination device is provided. Further, the light guides are arranged so as not to overlap one another. This makes it possible to realize reduction in thickness of the device.

Still further, in an illumination device of the present invention, the light sources are aligned such that the light source positioned at the midsection of the light source array that lies along one end part of the light guide has the highest luminous intensity, and luminous intensities of the other light sources decrease with distance from the light source disposed at the midsection of the light source array toward light sources disposed at edges of the light source array.

According to the above configuration, it is possible to prevent, in the discontinuous side edge surfaces of the light guide, the occurrence of coloration attributed to the color of light from the light sources disposed in the positions close to the side edge surfaces. In addition, it is possible to reduce coloration in areas positioned slightly inside the side edge surfaces of the light guide, and thus to sufficiently mix colored light beams together in the entire area of the light guide. This makes it possible to obtain white light without coloration.

An illumination device of the present invention may be configured such that the plurality of light sources are aligned in a given order along the two opposite end parts of each of the light guides, and the light sources aligned along one of the two opposite end parts emit light beams toward the light sources aligned along the other of the two opposite end parts.

According to the above configuration, the light source arrays aligned along the respective end parts so as to be opposed to each other can emit light beams toward the light guide. Thus, irradiation of light can be performed in such a complementary manner that light from one of the opposite light source arrays reaches the area (dead area) which is inaccessible to light from the other light source array. With this configuration, one of the light source arrays emits light so as to complement the dead area of the other of the light source arrays, so that light is emitted from the entire light-emitting surface. This makes it possible to improve luminance uniformity of light from the illumination device.

An illumination device of the present invention may be configured such that each of the light sources is a red light-emitting diode, a green light-emitting diode, or a blue light-emitting diode, and the light sources are constituted by a combination of the red, green, and blue light-emitting diodes.

According to the above configuration, it is possible to obtain an illumination device having light sources with a wide range of color reproduction.

In addition, with the above configuration, the light-emitting diodes of the following colors: red (R), green (G), and blue (B) are arranged such that their luminous intensities decrease with distance from the light-emitting diode disposed at the midsection of the light guide toward the light-emitting diodes disposed at the edges of the light guide. Thus, it is possible to obtain white light generated by sufficient mixture of the colored light beams.

An illumination device of the present invention may be configured such that luminous intensity adjusting means is provided for adjusting the luminous intensity of each of the light sources by controlling a value of a current to be supplied to each of the light sources.

According to the above configuration, the value of the current to be supplied to each of the light sources is controlled. Therefore, it is possible to sufficiently mix the colored light beams in the entire area of the light guide. In addition, the value of the current to be supplied decreases with distance from the light source disposed at the midsection of one end part of the light guide toward the light sources disposed at the furthest positions. It is therefore possible to realize reduction of power consumption.

An illumination device of the present invention may be configured such that luminous intensity adjusting means is provided for adjusting the luminous intensity of each of the light sources by controlling a pulse width of a current to be supplied to each of the light sources.

According to the above configuration, the pulse width of the current to be supplied to each of the light sources is controlled. This makes it possible to sufficiently mix the colored light beams in the entire area of the light guide. In addition, the pulse width of the current to be supplied decreases with distance from the light source disposed at the midsection of one end part of the light guide toward the light sources disposed at the furthest positions. It is therefore possible to realize reduction of power consumption.

An illumination device of the present invention may be configured such that the plurality of light sources are aligned along the light guide in such a manner that the luminous intensities of the light sources with respect to values of currents to be supplied decrease with distance from the light source disposed at the midsection of the light guide toward light sources disposed at edges of the light guide.

According to the above configuration, the light sources having different luminous intensity levels relative to a given value of a current supplied are used. This eliminates the need for change of the value of the current to be supplied to each of the light sources from the driving circuit or the like. Therefore, it is possible to simplify the configuration of the driving circuit, and thus to reduce manufacturing cost.

In order to solve the above problems, a liquid crystal display device according to the present invention includes: a liquid crystal display panel; and a backlight for emitting light beams to the liquid crystal display panel, wherein the backlight is any one of the above-described illumination devices.

A liquid crystal display device of the present invention includes an illumination device of the present invention as a backlight. With this configuration, it is possible to irradiate a liquid crystal display panel with white light generated by sufficient mixture of colored light beams, and thus to improve display quality.

Additional objects, features, and strengths of the present invention will be made clear by the description below. Further, the advantages of the present invention will be evident from the following explanation in reference to the drawings.

### BRIEF DESCRIPTION OF DRAWINGS

(a) of FIG. 1 is a cross-sectional view showing the configuration of a liquid crystal display device according to one embodiment of the present invention, and (b) of FIG. 1 is a plan view schematically showing a planar configuration of a light source unit provided in the liquid crystal display device according to one embodiment of the present invention.

FIG. 2 is a plan view schematically showing the configuration of a backlight provided in the liquid crystal display device shown in (a) of FIG. 1.

FIG. 3 is a plan view schematically showing the configuration of a light guide unit included in the backlight shown in FIG. 2.

FIG. 4 is an explanatory view of the amount of light from a plurality of light sources aligned in a line along a light guide.

FIG. 5 is a graph showing chromaticity “x” of the light guide in a case where luminous intensities of the aligned light-emitting diodes are varied as shown in FIG. 4 and in a case where the luminous intensities of the light-emitting diodes are equal to one another. The case where the luminous intensities of the light-emitting diodes are varied as shown in FIG. 4 is indicated by alternate long and short dashed lines, and the case where the luminous intensities of the light-emitting diodes are equal to one another is indicated by solid lines.

FIG. 6 is a graph showing chromaticity “y” of the light guide in a case where luminous intensities of the aligned light-emitting diodes are varied as shown in FIG. 4 and in a case where the luminous intensities of the light-emitting diodes are equal to one another. The case where the luminous intensities of the light-emitting diodes are varied as shown in FIG. 4 is indicated by alternate long and short dashed lines, and the case where the luminous intensities of the light-emitting diodes are equal to one another is indicated by solid lines.

FIG. 7 is a plan view schematically showing the configuration of a light source unit included in the conventional backlight.

### DESCRIPTION OF EMBODIMENTS

The following will describe one embodiment of the present invention with reference to FIGS. 1 through 6. Note that the following description is not intended to limit the scope of the present invention.

In the present embodiment, a tile-type backlight having a plurality of light guides are arranged all in the same plane so as not to overlap one another will be described.

FIG. 1 schematically shows the configuration of a liquid crystal display device 21 according to the present embodiment. (a) of FIG. 1 is a cross-sectional view of the liquid crystal display device 21, and (b) of FIG. 1 is a plan view schematically showing a planar configuration of the light source unit 32 provided in the liquid crystal display device 21. The liquid crystal display device 21 includes a backlight 22 (illumination device) and a liquid crystal display panel 23 that is opposed to the backlight 22.

The liquid crystal display panel 23 has a configuration similar to that of a general liquid crystal display panel for use in the conventional liquid crystal display device. The liquid crystal display panel 23, for example, includes (although not shown): an active matrix substrate with a plurality of TFTs (thin-film transistors) provided thereon; a color filter (CF) substrate that is opposed to the active matrix substrate, and a liquid crystal layer between the two substrates which is sealed with a sealing material.

Next, the following will describe the configuration of the backlight 22 included in the liquid crystal display device 21.

The backlight 22 is provided behind the liquid crystal display panel 23 (on a surface side which is opposite to a display surface). As shown in (a) of FIG. 1, the backlight 22 includes substrates 24, light sources 25, reflecting sheets 26, light guides 27, a diffusing plate 28, an optical sheet 29, a transparent plate 30, and drivers 31 (luminous intensity adjusting means).

Each of the light sources 25 is, for example, a dotted light source such as a side light-emitting type light-emitting diode (LED). The following description will take LEDs as an example of the light sources 25. In the present embodiment, used as the light sources 25 are the following side light-emitting type LEDs that respectively emit light beams of three different colors: a red light-emitting diode that emits light of red (R), a green light-emitting diode that emits light of green (G), and a blue light-emitting diode that emits light of blue (B). With this configuration, it is possible to obtain an illumination device with a wide range of color reproduction. Note that the light sources 25 are placed on the substrates 24. However, the present invention is not limited to such a configuration. The light sources 25 may be anything as long as they are a plurality of light sources that emit light beams of two or more different colors.

Each of the light guides 27 converts light beams emitted from the light sources 25 to surface emission from a light-emitting surface 27a. The light-emitting surface 27a is a surface for irradiating a target with light. Since a backlight of the present invention has a plurality of light sources that emit light beams of two or more different colors, a light guide has a capability of mixing the light beams of different colors from the light sources and converting the colored light beams thus mixed to surface emission.

Further, the light guide 27 is formed from a transparent resin such as polycarbonate (PC) or polymethylmethacrylate (PMMA). However, this is not the only possibility. The light guide 27 is preferably formed from a material with high transmittance. Still further, the light guide 27 can be formed by a method such as injection molding, extrusion molding, press molding with heat, or cutting, for example. However, the present embodiment is not limited to the methods. Any processing method can be employed as long as it brings about properties similar to those of any of the methods.

Each of the reflecting sheets 26 is provided so as to be in contact with a back surface of the light guide 27 (a surface opposite to the light-emitting surface 27a). The reflecting sheet 26 reflects light so that the light-emitting surface 27a emit more amount of light. The backlight 22 of the present embodiment includes a plurality of light guides 27, and each of the reflecting sheets 26 is provided for each of the light guides 27.

The diffusing plate 28 is opposed to the light-emitting surfaces 27a so as to cover the entire area of the light-emitting surfaces 27a of the light guides 27 which surfaces are flush with each other. The diffusing plate 28 diffuses light beams emitted from the light-emitting surfaces 27a of the light guides 27 and then irradiates the later-described optical sheet 29 with the diffused light beams. In the present embodiment, a 2.0 mm-thick “SUMIPEX E RMA10” manufactured by Sumitomo Chemical Co., Ltd is used as the diffusing plate 28. The diffusing plate 28 may be placed at a predetermined distance from the light-emitting surfaces 27a. The predetermined distance is set to 3.0 mm, for example.

The optical sheet 29 is placed in the front of the light guides 27 and is made up of a plurality of sheets stacked on top of each other. The optical sheet 29 uniforms and converges light emitted from the light-emitting surface 27a of the light guide 27 and then irradiates the liquid crystal display panel 23 with the uniformed and converged light. That is, the optical sheet 29 can be realized by sheets such as (i) a diffusing sheet for simultaneously converging and diffusing incident light, (ii) a lens sheet for converging incident light so as to improve luminance obtained when viewed from a front direction (i.e., a direction pointing to the liquid crystal display panel), and (iii) a polarizing and reflecting sheet for reflecting one polarized component of light and transmitting the other polarized component so as to improve luminance of the liquid crystal display device 21.

It is preferable that these sheets are appropriately combined with each other in consideration of an intended price and/or performance of the liquid crystal display device 21. In the present embodiment, as an example, “LIGHT-UP 250GM2” manufactured by Kimoto Co., Ltd. is used as the diffusing sheet, “Thick RBEF” manufactured by Sumitomo 3M Ltd. is used as a prism sheet, and “DBEF-D400” manufactured by Sumitomo 3M Ltd. is used as a polarizing sheet.

The transparent plate 30 is used for the purpose of keeping a distance between the light guide 27 and the diffusing plate 28 at a given distance, and forms a light-diffusing region. The transparent plate 30 is formed from a transparent material such as a polyethylene film. Optionally, the transparent plate 30 may be omitted so that the light guide 27 and the diffusing plate 28 are opposed to each other.

The drivers 31 each perform lighting control of the light sources 25, and functions as luminous intensity adjusting means for adjusting luminous intensity of light emitted from the light sources 25. The driver 31 is placed on the undersurface of the substrate 24 (on the side opposite to the side where the light source 25 is provided). The drivers 31 perform lighting control by supplying electric currents, etc. to the light sources 25. Therefore, the driver 31 can be also termed a light source control section.

In the present embodiment, the backlight 22 includes a plurality of light guides. As shown in (a) and (b) of FIG. 1, the backlight 22 is configured such that a plurality of light source units 32 are arranged all in the same plane so as not to overlap one another. Each of the light source units 32 is a combination of one light guide 27 and a plurality of light sources 25.

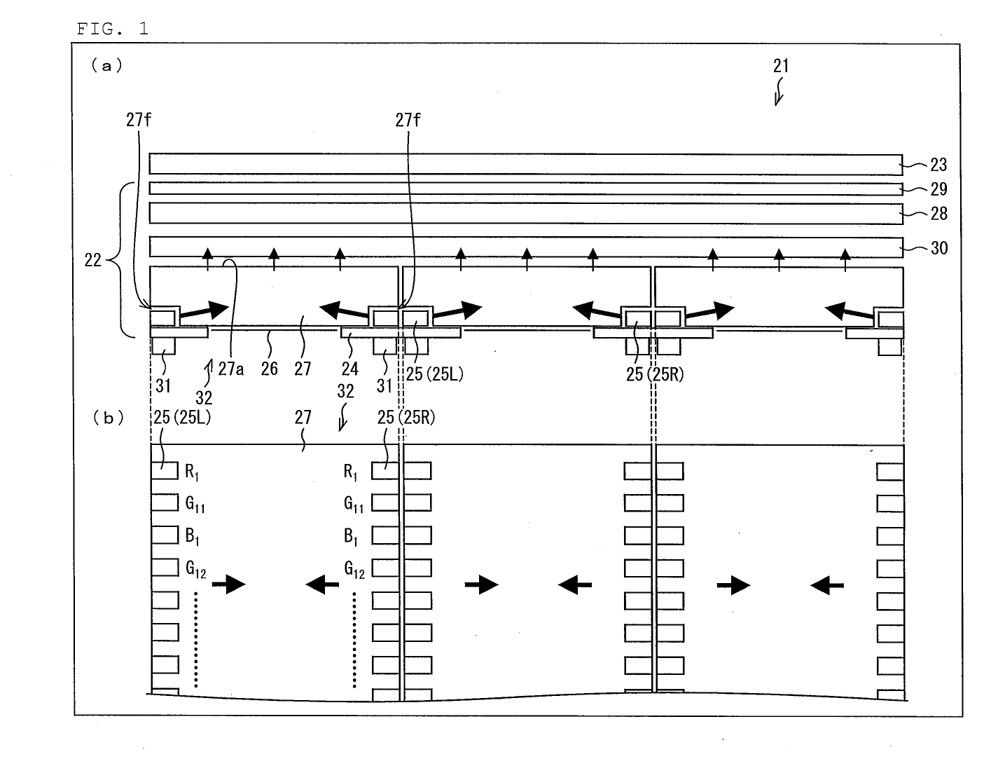

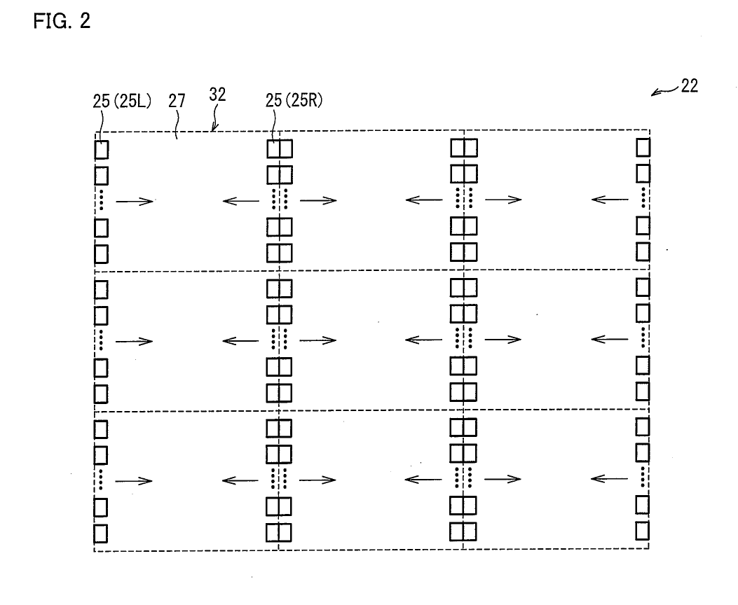

FIG. 2 schematically shows a planar configuration of the backlight 22. As shown in FIG. 2, the backlight 22 is configured such that the plurality of light source units 32 are arranged lengthwise and crosswise. In this manner, the backlight 22 of the present embodiment is such that the plurality of light source units 32 are arranged as if tiles are spread over the backlight 22. Therefore, the backlight 22 of the present embodiment is termed a tile-type backlight.

With use of such a tile-type backlight, it is possible to realize a sufficient luminance and excellent luminance uniformity even in a case where the tile-type backlight is employed in a large liquid crystal display device. Further, with such a configuration that the light guides are arranged so as not to overlap one another, it is possible to realize reduction in thickness of the device.

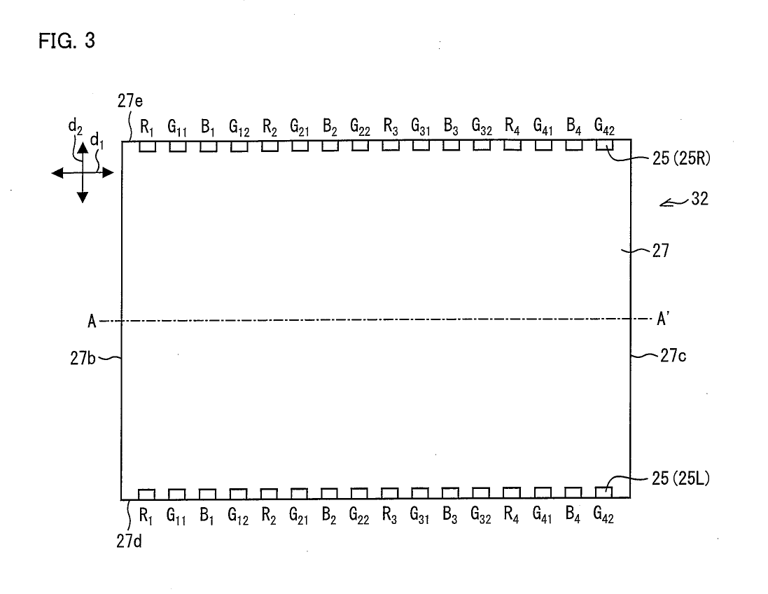

FIG. 3 shows the configuration of one of the light source units 32 included in the backlight 22. FIG. 3 is a plan view (top view) of the light source unit 32 when the plurality of light source units 32 arranged in a tiled manner are viewed from the liquid crystal display panel 23 side (which is assumed to be a top surface side).

As shown in FIG. 3, one light source unit 32 includes: one light guide 27 for converting light from the light sources to surface emission; and a plurality of light sources 25 arranged in a given order along two opposite end parts 27d and 27e of the light guide 27. As indicated in the light guide 27 of FIG. 3, a direction where the light sources are aligned is referred to as a width direction d1 of the light guide, and a direction substantially orthogonal to the width direction d1 is referred to as a length direction d2 of the light guide.

In (a) and (b) of FIG. 1, the light sources 25 aligned in a row along a left-hand end part of the two opposite end parts of the light guide 27 are given reference sign 25L, and the light sources 25 aligned in a row along a right-hand end part of the two opposite end parts of the light guide 27 are given reference sign 25R. Further, as shown in (a) of FIG. 1, the light sources 25 (25L and 25R) are placed in hollow-like concavities 27f that are provided inside the light guide 27.

The light sources 25L and 25R are placed on the substrate 24. As shown in (a) and (b) of FIG. 1, a direction (indicated by arrows) in which light is emitted from the light sources 25L and 25R is adjusted in such a manner that light from one array of light sources (e.g. the array of the light sources 25L) is directed toward the other array of light sources (e.g. the array of the light sources 25R). In other words, the light sources 25 emit light toward the midsection of the light guide 27 in the length direction d2.

As described above, in the light source unit 32, the light source arrays in two rows opposed to each other are arranged in such a manner that light from one of the light source arrays covers the area which is inaccessible to light from the other light source array. With this configuration, one of the light source arrays emits light so as to complement a dead area of the other of the light source arrays, so that light is emitted from the entire light-emitting surface. This makes it possible to improve luminance uniformity of light from the backlight 22.

In other words, the array of the light sources 25L and the array of the light sources 25R are opposed to each other so that light beams from both of the light source arrays are directed into the inside of the light guide 27. This makes it possible to cause light-emitting areas of the respective light sources to overlap, and thus to obtain emission of light from the entire light-emitting surface 27a of the light guide 27.

In the present embodiment, a plurality of light source units 32 with the above-described configuration are arranged. This makes it possible to obtain a large backlight that produces no dark areas. Further, as shown in (a) of FIG. 1, the backlight 22 of the present embodiment is configured such that the light source units 32 are arranged all in the same plane so as not to overlap one another. This results in a flush light-emitting surface (light-emitting surface of the whole backlight 22; light-emitting area) formed by the light-emitting surfaces 27a of the respective light guides 27.

With the above configuration, light emitted from the light sources 25 travels through the inside of the light guide 27 while being subjected to scattering action and reflecting action. Then, the light exits from the light-emitting surface 27a, passes through the diffusing plate 28 and the optical sheet 29, and finally reaches the liquid crystal display panel 23.

As described above, the plurality of light sources 25 are mounted on the substrate 24 and each aligned along one end part of the light guide 27. In the present embodiment, the LEDs of the following three colors: red (R), green (G), and blue (B) are used as the light sources 25. As shown in FIG. 3, the light sources are aligned along the end parts 27d and 27e of the light guide 27 in a direction pointing from one side surface 27b of the light guide 27 to the other side surface 27c that is opposite to the side surface 27b, in the following order: R1, G11, B1, G12, R2, G21, B2, G22, . . . R4, G41, B4, and G42. The light sources are aligned with a sequence of R, G, B, and G as one group. As shown in FIG. 3, the light source unit 32 of the present embodiment is such that the plurality of light sources 25 are aligned in a given order along the two opposite end parts 27d and 27e of the light guide 27. In FIG. 3, the light sources aligned along the end part 27d each are given reference numeral 25L, and the light sources aligned along the end part 27e each are given reference numeral 25R.

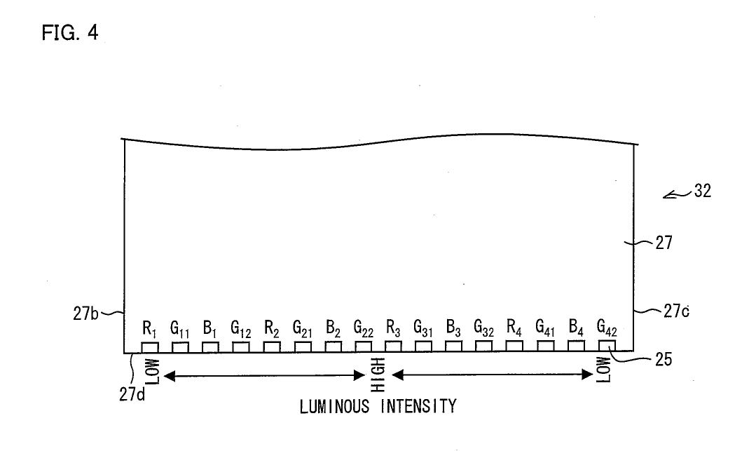

FIG. 4 shows a relation between the luminous intensities of the light sources aligned in a given order along one end part 27d of the light guide 27. As shown in FIG. 4, the light source unit 32 is arranged such that the light sources (e.g. G22 and R3) positioned in the midsection of one end part of the light guide have the highest luminous intensity among the plurality of light sources aligned in a line along the light guide, and luminous intensities of the other light sources decrease with distance from the light sources having the highest luminous intensity. Conversely, the light sources 25 (e.g. R1 and G42) arranged at the positions closest to the side surfaces 27b and 27c of the light guide have the lowest luminous intensity, and luminous intensities of the other light sources increase with distance toward the light sources positioned near the midsection of each end part of the light guide. As in the above case, at the other end part 27e opposite to the end part 27d, the light sources 25R positioned in the midsection of the end part 27e have the highest luminous intensity among the light sources 25R aligned in a line, and luminous intensities of the other light sources 25R decrease with distance from the light sources having the highest luminous intensity (not shown).

With the above-described setting of the luminous intensities of the light sources 25, it is possible to prevent, in the discontinuous side edge surfaces 27b and 27c of the light guide 27, the occurrence of coloration attributed to the color of light from the light sources disposed in the positions close to the side edge surfaces. In addition, it is possible to reduce coloration in areas positioned slightly inside the side edge surfaces of the light guide. Thus, it is possible to sufficiently mix colored light beams together in the entire area of the light guide. This makes it possible to obtain the backlight 22 that emits white light without coloration.

Further, with the above configuration, the LEDs of colors R, G, B are such that the colored light-emitting diodes increase in luminous intensity toward the midsection of the end parts of the light guide with distance from the edges of the end parts of the light guide.

Specifically, the relations in luminous intensity between the LEDs of each color are expressed by:
R1<R2<R3>R4;
G11<G12<G21<G22>G31>G32>G41>G42; and
B1<B2>B3>B4.

The color combination of the LEDs and the color sequence of the LEDs are not limited to the above examples. Further, the light sources are preferably spaced at a given interval, but do not need to be so disposed.

Instead of being arranged with a color sequence of “R, G, B, and G” as one group, the LEDs may be arranged, for example, with a sequence of “G, R, B, and G” as one group as described in Patent Literature 5, paragraph [0250]. Such an arrangement of the LEDs R, G, and B makes it possible to further improve color mixture.

As described above, in the present embodiment, in the light source array in which the light sources are aligned in a line along the end parts 27d and 27e, the light source 25 positioned at the midsection of the end part has the highest luminous intensity, and luminous intensities of the other light sources 25 decrease with distance from the light source positioned at the midsection of the end part (i.e. with increasing proximity to the side surfaces 27b and 27c of the light guide 27).

In this case, adjustment of luminous intensities of the light sources 25 can be achieved by a method of controlling values of electric current to be supplied from the driver 31 to the LEDs. Examples of other method for adjusting the luminous intensities include a method of decreasing width of a pulse to be supplied from the driver 31 to each of the LEDs. In this manner, the driver 31 serves as luminous intensity adjusting means by performing drive control of the LEDs.

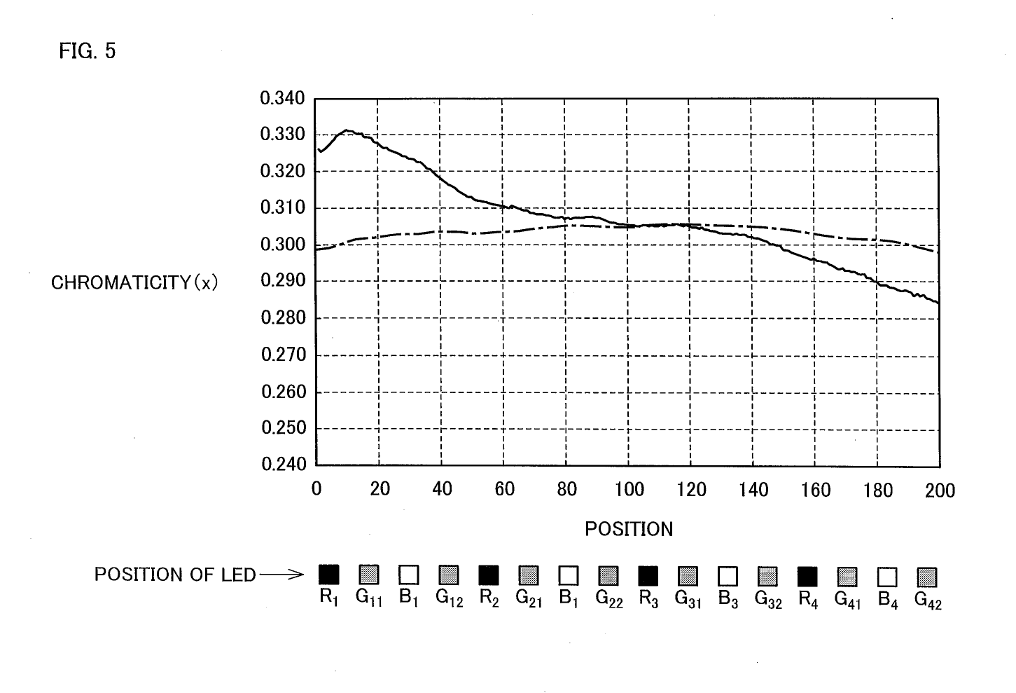

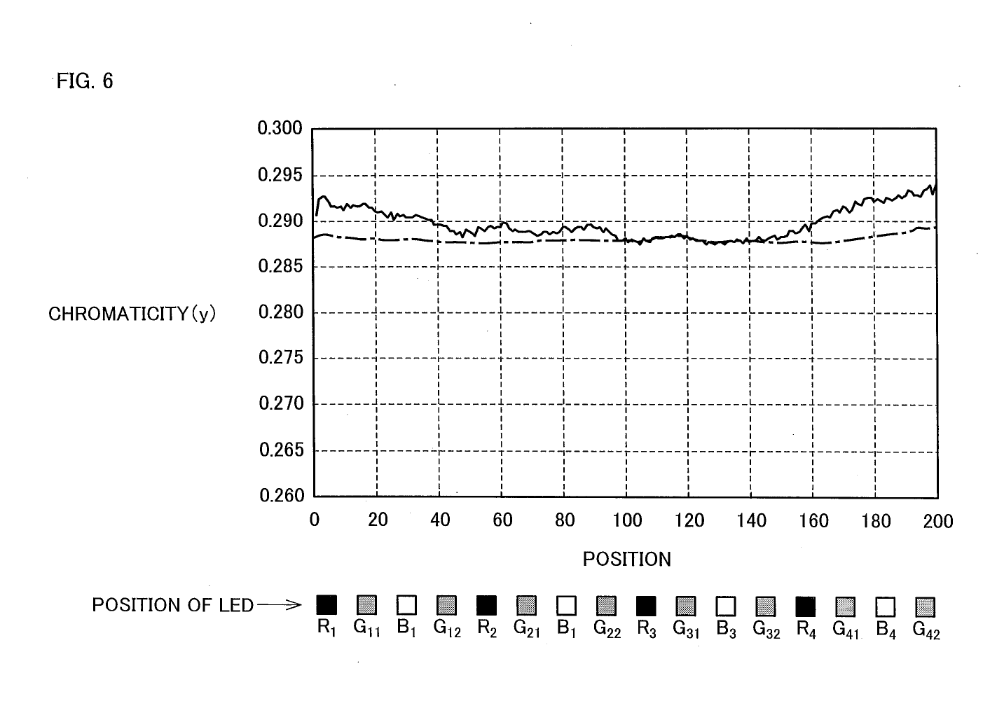

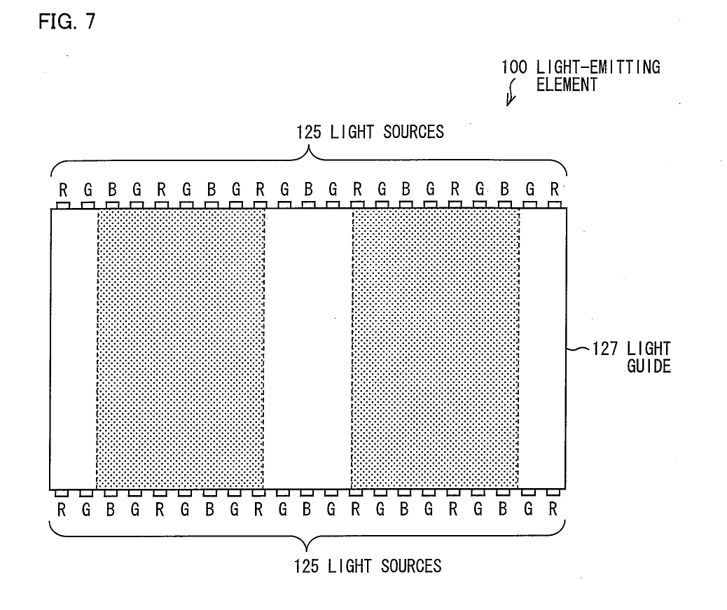

FIG. 5 is a graph showing chromaticity “x” of a section A-A′ shown in FIG. 3 in a case where the luminous intensities of the aligned LEDs are varied as shown in FIG. 4 and in a case where the luminous intensities are equal to one another. FIG. 6 is a graph showing chromaticity “y” of a section A-A′ shown in FIG. 3 in a case where the luminous intensities of the aligned LEDs are varied as shown in FIG. 4 and in a case where the luminous intensities are equal to one another. In FIGS. 5 and 6, a lateral axis indicates positions on the end part 27d of the light guide. The lateral axis is divided by tick marks that represent the positions of the LEDs in the following manner. That is, the position closest to one side surface 27b of the light guide 27 is “0”, the position in the midsection is “100”, and the position closest to the other side surface 27c is “200”. In FIGS. 5 and 6, the case where the luminous intensities of the light-emitting diodes are varied as shown in FIG. 4 is indicated by alternate long and short dashed lines, and the case where the luminous intensities of the light-emitting diodes are equal to one another is indicated by solid lines.

In the case where the luminous intensities of the LEDs are equal to one another, results are as indicated by the solid lines in FIGS. 5 and 6. That is, there is little difference in chromaticity “y” between the opposite edge surfaces 27b and 27c of the light guide, while a value of chromaticity “x” at the position on one edge surface 27b side of the light guide is comparatively higher than that of chromaticity “x” at the position on the other edge surface 27c side of the light guide. On this account, red coloration occurs at the position on one edge surface 27b side of the light guide. However, in the case where the luminous intensities of the LEDs are varied as in the present embodiment, results are as indicated by the alternate long and short dashed lines in FIGS. 5 and 6. That is, both chromaticity “x” and chromaticity “y” remain constant at any positions on the light guide. Thus, it is possible to obtain a uniformly-white illumination device.

Further, as an alternate method for setting the luminous intensities of the light sources 25 as described above, the LEDs aligned in a line along the end parts 27d and 27e of the light guide 27 may be selected in such a manner that an LED with high-rank luminous intensity is used as the LED positioned around the midsection of the light guide while an LED with low-rank luminous intensity is used as the LED positioned around the side edge surfaces 27b and 27c of the light guide. The “LED with high-rank luminous intensity” is an LED that emits light of higher luminous intensity with respect to a supplied current, as compared with “LED with low-rank luminous intensity”. In other words, a luminous intensity rank means a property of an LED determined by a magnitude of luminous intensity of light emitted when a current of the same value is supplied.

That is, in the above configuration, the plurality of light sources 25 are aligned in a row along the end parts 27d and 27e of the light guide 27 in such a manner that the luminous intensities of the light sources with respect to a supplied current decreases with increasing proximity to the side surfaces 27b and 27c of the light guide 27 from the midsections of the end parts 27d and 27e of the light guide 27.

With this configuration, it is possible to set the luminous intensities of the respective light sources to target values without change in value of a current to be supplied from the driver to the light sources. Consequently, it is possible to simplify the structure of the driver, and thus to reduce a manufacturing cost.

An illumination device of the present invention has an excellent luminance uniformity even in a case where its light-emitting area is large. Thus, the illumination device is particularly preferably used as a backlight for a liquid crystal display device having a large screen.

However, the applicability of the present invention is not limited to this. An illumination device of the present invention can be used as a backlight for every liquid crystal display device.

The present invention is not limited to the aforementioned embodiments and is susceptible of various changes within the scope of the accompanying claims. Also, embodiments obtained by suitable combinations of technical means disclosed in the different embodiments are also included within the technical scope of the present invention.

An illumination device according to the present invention is configured such that: the plurality of light guides are arranged so as not to overlap one another, and the plurality of light sources are aligned in a given order along end parts of each of the light guides; and a light source disposed at a midsection of the end part of the light guide has the highest luminance intensity among the plurality of light sources, and luminous intensities of the other light sources decrease with distance from the light source disposed at the midsection of the end part of the light guide.

Hence, it is possible to realize: an illumination device capable of providing white light generated by sufficient mixture of colored light beams, without coloration attributed to colors of light beams from light sources.

Specific embodiments or examples implemented in the description of the embodiments only show technical features of the present invention and are not intended to limit the scope of the invention. Variations can be effected within the spirit of the present invention and the scope of the following claims.

### INDUSTRIAL APPLICABILITY

An illumination device of the present invention, which is capable of providing white light generated by sufficient mixture of colored light beams, is suitably used as a backlight for use in a liquid crystal display device. With use of an illumination device of the present invention, it is possible to realize improvement of display quality of a liquid crystal display device.

### REFERENCE SIGNS LIST

21 liquid crystal display device
22 backlight (illumination device)
23 liquid crystal display panel
25 (25L, 25R) light source (LED)
27 light guide
27a light-emitting surface
27b, 27c side surfaces (of the light guide)
27d, 27e end parts (of the light guide)
31 driver (luminous intensity adjusting means)

1. An illumination device comprising:
a plurality of light sources which emit light beams of two or more different colors; and
a plurality of light guides each of which mixes colored light beams emitted from the light sources and then converts the colored light beams thus mixed into surface emission, wherein
the plurality of light guides are arranged so as not to overlap one another,
the plurality of light sources are aligned in a given order along end parts of each of the light guides, and
a light source disposed at a midsection of the end part of the light guide has the highest luminance intensity among the plurality of light sources, and luminous intensities of the other light sources decrease with distance from the light source disposed at the midsection of the end part of the light guide.

2. The illumination device according to claim 1, wherein
the plurality of light sources are aligned in a given order along the two opposite end parts of each of the light guides, and
the light sources aligned along one of the two opposite end parts emit light beams toward the light sources aligned along the other of the two opposite end parts.

3. The illumination device according to claim 1, wherein
each of the light sources is a red light-emitting diode, a green light-emitting diode, or a blue light-emitting diode, and
the light sources are constituted by a combination of the red, green, and blue light-emitting diodes.

4. The illumination device according to claim 1, wherein
luminous intensity adjusting means is provided for adjusting the luminous intensity of each of the light sources by controlling a value of a current to be supplied to each of the light sources.

5. The illumination device according to claim 1, wherein
luminous intensity adjusting means is provided for adjusting the luminous intensity of each of the light sources by controlling a pulse width of a current to be supplied to each of the light sources.

6. The illumination device according to claim 1, wherein
the plurality of light sources are aligned along the light guide in such a manner that the luminous intensities of the light sources with respect to values of currents to be supplied decrease with distance from the light source disposed at the midsection of the light guide toward light sources disposed at edges of the light guide.

7. A liquid crystal display device comprising:
a liquid crystal display panel; and
a backlight for emitting light beams to the liquid crystal display panel, wherein the backlight is an illumination device according to claim 1.
